(19) United States
(12) Patent Application Publication
(10) Pub. No.: US 2020/0342306 A1
(43) Pub. Date: Oct. 29, 2020

(54) AUTONOMOUS MODIFICATION OF DATA

(71) Applicant: International Business Machines Corporation, Armonk, NY (US)

(72) Inventors: Andrea Giovannini, Zurich (CH); Antonio Foncubierta Rodriguez, Zurich (CH); Maria Gabrani, Thalwil (CH); Apostolos Krystallidis, Zurich (CH)

(21) Appl. No.: 16/394,493

(22) Filed: Apr. 25, 2019

(51) Int. Cl. G06N 3/08; G06N 3/04; G06N 20/20

(52) U.S. Cl. CPC G06N 3/08; G06N 20/20; G06N 3/0454

(57) ABSTRACT

A computer-implemented method for modifying patterns in datasets using a generative adversarial network may be provided. The method comprises providing pairs of data samples. The pairs comprise each a base data sample and a modified data sample. Thereby, the modified pattern is determined by applying random modifications to the base data sample. Additionally, the method comprises training of the generator for building a model of the generator using an adversarial training method and using the pairs of data samples as input, wherein the discriminator receives as input dataset pairs of datasets, the dataset pairs comprising each a prediction output of the generator based on a base data sample and the corresponding modified data sample, thereby optimizing a joint loss function for the generator and the discriminator, and predicting an output dataset for unknown data samples as input for the generator without the discriminator.

### BACKGROUND

The invention relates generally to autonomously changing data patterns, and more specifically, to a computer-implemented method for modifying patterns in datasets using a generative adversarial network. The invention relates further to a corresponding machine-learning system for modifying patterns in datasets using a generative adversarial network, and a computer program product.

Artificial Intelligence (AI) in the special form of machine-learning is broadly introduced in enterprise deployment and as part of enterprise applications. Software development is currently undergoing a transformation process away from linear programming to training of machine-learning (ML) models. However, it has turned out that training of ML systems is not a piece of cake, but a highly complex undergoing which success raises and falls with the availability of training data. The prediction results of ML systems is only as good as the training data are. However, good training data need typically good annotations or labeling to be interpreted correctly by the ML system in order to develop a successful model.

Thus, programming is not anymore the most time-expensive part of the process, nowadays. With the coming-back of machine learning, labeling becomes a substantial part in the development of novel tools. Indeed, the number of samples needed by the machine learning based processes scales with the complexity of the input. For example, the LSVRC-2010 ImageNet training set comprises more than 1.3 million images organized into 1000 classes (Sutskever, Hinton, & Krizhevsky, 2012).

In this context, Generative Adversarial Networks (GANs) started gaining traction as a way of capturing the inherent distribution of a dataset (Goodfellow, et al., 2014), leading to applications like data augmentation (Antoniou, Storkey, & Edwards, 2018), where synthetically generated samples can be used to train other AI models.

### SUMMARY

According to one aspect of the present invention, a computer-implemented method for modifying patterns in datasets using a generative adversarial network may be provided. The generative adversarial network may comprise a generator and a discriminator. The method may comprise providing pairs of data samples. The pairs may comprise each a base data sample with a pattern and a modified data sample with a corresponding modified pattern. The modified pattern may be determined by applying at least one random modification to the base data sample.

The method may further comprise, training of the generator for building a model of the generator using an adversarial training method and using the pairs of data samples as input. Thereby, the discriminator may receive as input dataset pairs of datasets, wherein the dataset pairs may comprise each a prediction output of the generator based on a base data sample and the corresponding modified data sample, whereby a joint loss function for the generator and the discriminator may be optimized.

Furthermore, the method may comprise predicting an output dataset for unknown data samples as input for the generator without the discriminator, i.e., the discriminator may be removed.

According to another aspect of the present invention, a machine-learning system for modifying patterns in datasets using a generative adversarial network may be provided. The generative adversarial network may comprise a generator network system and a discriminator network system. The machine-learning system may comprise a receiving unit adapted for providing pairs of data samples. The pairs may comprise each a base data sample with a pattern and a modified data sample with a corresponding modified pattern. The modified pattern may be determined by applying at least one random modification to the base data sample.

The system may further comprise a training module adapted for controlling a training of the generator network system for building a model of the generator network system using an adversarial training method and using the pairs of data samples as input. Thereby, the discriminator network system may receive as input dataset pairs of datasets. The dataset pairs may comprise each a prediction output of the generator based on a base data sample and the corresponding modified data sample. Thereby, a joint loss function for the generator and the discriminator may be optimized.

The system may additionally comprise a prediction unit adapted for predicting an output dataset for unknown data samples as input for the generator without the discriminator.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain means for storing, communicating, propagating or transporting the program for use, by, or in connection, with the instruction execution system, apparatus, or device.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above, and further aspects of the present invention, are apparent from the examples of embodiments to be described hereinafter and are explained with reference to the examples of embodiments, but to which the invention is not limited.

Preferred embodiments of the invention will be described, by way of example only, and with reference to the following drawings:

FIG. 1 shows a block diagram of an embodiment of the inventive computer-implemented method for modifying patterns in datasets using a generative adversarial network.

FIG. 2 shows a general setup of the here proposed system used by the proposed method.

FIG. 3 shows main process steps.

FIG. 4 shows an example of a pattern forward to be modified and ground truth data for modified output for and ground truth for modified output.

FIG. 5 shows an example transforming a damaged input image to a modified output 1 and modified output 2.

FIG. 6 is an example 600 of a reconstruction of a phase diagram.

FIG. 7 shows another example 700 involving forms.

FIGS. 8, 9 show other examples of a pretty challenging dataset of a very noisy scanned document.

FIGS. 10, 11 show as examples involving another generator trained to “decoupling” noise from documents in series with the generator.

FIG. 12 shows a block diagram of an embodiment of the inventive machine-learning system for modifying patterns in datasets using a generative adversarial network.

FIG. 13 shows a block diagram of a computing system comprising the machine-learning system according to FIG. 12.

### DETAILED DESCRIPTION

In the context of this description, the following conventions, terms and/or expressions may be used:

The term ‘generative adversarial network’ (GAN) denotes a class of machine-learning systems. Two neural networks may contest with each other in a zero-sum game framework. This technique may generate, e.g., photographs that look at least superficially authentic to human observers, having many realistic characteristics. It may represent a form of unsupervised learning.

The generative or generator network may generate candidates while the discriminative network evaluates them. The contest may operate in terms of data distributions. Typically, the generative network may learn to map from a latent space to a data distribution of interest, while the discriminative network may distinguish candidates produced by the generator from the true data distribution. The generative network's training objective may be to increase the error rate of the discriminative network (i.e., “fool” the discriminator network) by producing novel candidates that the discriminator may think are not synthesized, i.e., are part of the true data distribution.

A known dataset may serve as the initial training data for the discriminator. Training involves presenting patterns from the training dataset until acceptable accuracy is achieved. The generator may be trained based on whether it succeeds in fooling the discriminator. Typically, the generator may be seeded with randomized input that is sampled from a predefined latent space (e.g., a multivariate normal distribution). Thereafter, candidates synthesized by the generator may be evaluated by the discriminator. Backpropagation may be applied in both networks, so that the generator produces better images, while the discriminator may become more skilled at flagging synthetic images. The generator may typically be a de-convolutional neural network, and the discriminator is a convolutional neural network.

The term ‘neural network’ may denote a computing system inspired by the biological neural networks that constitute animal brains. The neural network itself may not only be an algorithm, but rather a framework for many different ML algorithms to work together and process complex data inputs. Such systems may “learn” to perform tasks by considering examples, generally without being programmed with any task-specific rules. The neural network may comprise a plurality of nodes as input layer, a plurality of hidden layers and a plurality of nodes at an output layer. The nodes may be connected layer-wise and may each comprise an activation function using input values from previous layer nodes. The number of nodes of hidden layers may be less than the number of nodes of the input and/or output layer de-convolutional neural network).

The term ‘generator’ may denote here a neural network with a plurality of layers, wherein the number of nodes of the input layer may be equal to the number of nodes of the output layer. This way, the generator or generator network, or generator network system, may generate output data with the same complexity—i.e., the same resolution—as the input data, i.e., a de-convolutional network.

The term ‘discriminator’ may denote an artificial neural network comprising the same number of input nodes as the generator has output nodes. Thus, the discriminator may not differentiate whether its input is an original-based data sample or a data sample generated by the generator just based on resolution parameters. The number of output nodes of the discriminator may be two. This is for differentiating between original data samples and artificially generated data samples output by the generator.

The term ‘data samples’ may denote, e.g., images, sound data, text data or any kind of other unstructured data. As unstructured data may be denoted those data that do not fit in the classical scheme of structured data like in a relational database.

The term ‘base data sample’ may denote an unmodified data sample used for training and/or also as input for a trained generator.

The term ‘modified data sample’ may denote a data sample relating to the base data sample having at least one modified feature if compared to the base data sample. A base data sample may always have a related modified data sample building a pair of data samples used for training.

The term ‘modified pattern’ may denote exemplarily—in case of an image as a data sample—that lines which are not continuous may be completed to continues lines, that colored lines are converted to black and white lines or, that lines are removed completely from a data sample so that form data and content data may be separated.

The term ‘joint loss function’ may denote a function measuring a content loss between a base data sample and a modified data sample. However, it may also be possible that they joined loss function may relate to added content. The important thing is that the content has changed.

The term ‘Wasserstein loss function’ (also denoted as Kantorovich-Rubinstein metric or distance) may denote a distance function defined between probability distributions on a given metric space. Intuitively, if each distribution is viewed as a unit amount of “dirt” piled on M, the metric is the minimum “cost” of turning one pile into the other, which is assumed to be the amount of dirt that needs to be moved times the mean distance it has to be moved. Because of this analogy, the metric is known in computer science as the earth mover's distance.

The term ‘PatchGAN’ may denote a convolutional neural network processing input data—e.g., images—in patches identically and independently which makes the processing very cheap in terms of required parameters, time and memory.

The term ‘VGG19’ may denote a pre-trained 19-layer neural network developed by the VGG team during ILSVRC-2014 competition. Details may be found at the following arXiv paper: Very Deep Convolutional Networks for Large-Scale Image Recognition, K. Simonyan, A. Zisserman, arXiv:1409.1556.

The term ‘ResNet-50’ may denote a 50 layer convolutional neural network for residual learning. In residual learning, instead of trying to learn some features, one may try to learn some residual. Residual may be simply understood as subtraction of features learned from input of that layer. ResNet does this using shortcut connections (directly connecting input of nth layer to some (n+x)th layer. It has been proven that training this form of networks may be easier than training simple deep convolutional neural networks and also the problem of degrading accuracy is resolved.

The proposed computer-implemented method for modifying patterns in datasets using a generative adversarial network may offer multiple advantages and technical effects:

The here proposed super resolution GAN may improve the training convergence and allowing a decoupling the architectures of the generator and the discriminator. With the option to implement the Wasserstein loss instead of the adversarial, the proposed method and system may lead to better results compared to any of the components alone on a standard architecture.

The generator may be similar to a U-NET so that low-level information may be passed directly to deeper layers so that the training becomes more efficient since skipped layers facilitate gradient back-propagation and radiant vanishing problems can be overcome for deeper networks. Additionally, the absence of dense layers may provide the flexibility of testing at different input shapes that the one used for training.

The optionally modified discriminator implemented as a PatchGAN allows a reduced number of power meters that are needed which may result in savings in memory and time, as well as the fact that the architecture can be applied to arbitrary input shapes.

In summary, the proposed method and the related system may allow a training of a neural network to deal with different kind of input data, separate different patterns as output data, deal with difficult, noisy input data and may also be applied to other data types than images. A major advantage is also that labeled or annotated data are not required; thus, the proposed concept may represent a special form of unsupervised learning allowing to reduce the manual effort during the training phase significantly.

In the following, additional embodiments—applicable to the method as well as to the corresponding system—will be described:

According to one advantageous embodiment of the method, the joint loss function may be a Wasserstein loss function, in particular, with gradient penalty. This may enable a particularly efficient training of the joint system comprising the generator and the discriminator.

According to one permissive embodiment, the method may also comprise training of different models for the generator network using the adversarial training method and using the pairs of data samples as input. Thereby, the modified data sample(s) may be modified according to a different aspect. Thus, a reconstruction of complete patterns may be implementable, as well as extracting form from input data as well as optimizing noisy documents. In some cases a serialization of differently trained generators may be recommended.

According to one preferred embodiment of the method, the generator may be a neural network having as many output nodes as input nodes and having less hidden layer nodes than the number of input nodes. This may be noted as de-convolutional neural network. This way, it may be possible to generate output data—e.g., images—having the same resolution as the input data for productive use or for training.

According to a preferred embodiment of the method, the discriminator may be a neural network having as many input nodes as the generator has output nodes and having two output nodes. The two output nodes may classify the input of the discriminator into “true” or “false” meaning “the input was artificially generated by the generator or the input was an original sample”. If the discriminator cannot differentiate the source of its input any longer, the generator's training can be seen as finalized.

According to one useful embodiment of the method, the discriminator may be a PatchGAN, i.e., a series of convolutional neural networks (CNNs) with batch normalization. Such a system may promise the best results with a fast convergence during training.

According to one advantageous embodiment of the method, the joint loss function may be a weighted combination of loss functions. This way, different aspects may be reflected during the training, and a good convergence during training according to various aspects may be reached.

According to another advantageous embodiment of the method, the loss function may be related to content loss of the base data sample, wherein the content loss is determined using a feature map of pre-trained neural network. This may actually be of the type VGG19 or ResNet-50.

According to one optional embodiment of the method, the modified data sample may comprise, in contrast to the relating data samples continuous lines instead of dashed lines, black-and-white instead of equivalent colored patterns, text-less patterns instead of patterns with text, and line-free images instead of mixed line/text images. Thus, the generator may be trained to add or subtract information during the inference phase in respect to the provided new input data.

According to one further developed embodiment of the method, the providing pairs of data samples may comprise providing a set of images with patterns, determining at least one pattern to be modified, randomly modifying the at least one pattern of the images using a random number generator, and relating one out of the set of images and a related image with the at least one pattern defining one of the pairs comprising the base data sample and the modified data sample. Thus, no labeled data may be required at all. This may increase the speed of adapting the proposed system to a variety of different application areas. Manual and labor intensive tasks may be eliminated during the training process.

According to one useful embodiment of the method, the training of the generative adversarial network may be terminated if a result of the joint loss function may be smaller than a relative threshold value if comparing the result of the current iteration with a previous iteration. This condition may—besides other options—mark an adaptable limitation of the training time for the generative adversarial network, and thus for the generator.

According to one optional embodiment of the method, the base data sample and the modified data sample may be images. However, also other data sample types like sound or text—or other so-called unstructured data—may be used as data samples. Further examples and consequences of such data samples will be explained below.

In the following, a detailed description of the figures will be given. All instructions in the figures are schematic. Firstly, a block diagram of an embodiment of the inventive computer-implemented method for modifying patterns in datasets using a generative adversarial network is given. Afterwards, further embodiments, as well as embodiments of the machine-learning system for modifying patterns in datasets using a generative adversarial network, will be described.

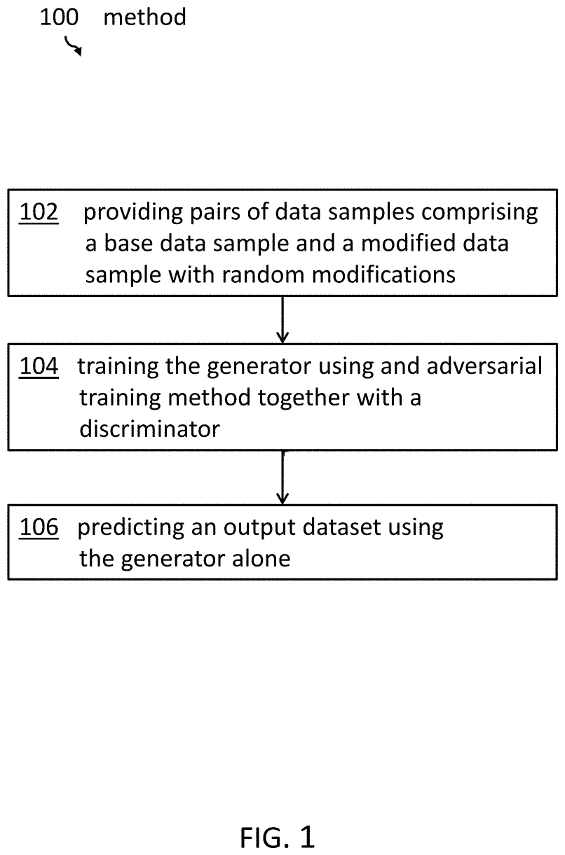

FIG. 1 shows a block diagram of an embodiment of the computer-implemented method 100 for modifying patterns in datasets using a generative adversarial network. The generative adversarial network comprises a generator and a discriminator. The method comprises providing, 102, pairs of data samples. Examples for the data samples may be images; however also other types of data samples may be provided, e.g., sound data, text data, and the like.

The pairs comprise each a base data sample with a pattern and a modified data sample with at least one corresponding modified pattern. The modification(s) may relate to, e.g., completed lines or, e.g., without a table pattern. The variety of different modified patterns may add additional elements into the base data sample or may reduce information from the base data sample. The modified pattern can, e.g., be determined by applying random modifications to the base data sample using a random number generator.

The method 100 also comprises training, 104, of the generator for building a model of the generator using an adversarial training method together with a discriminator and using the pairs of data samples as input. The discriminator receives as input dataset pairs of datasets. The dataset pairs comprise each a prediction output of the generator based on a base data sample and the corresponding modified data sample. Thereby, a joint loss function for the generator and the discriminator can be optimized.

Last but not least, the method 100 comprises predicting, 106, an output dataset for unknown data samples as input for the generator without the discriminator, i.e., the discriminator is removed and a productive use is possible with a generator network alone.

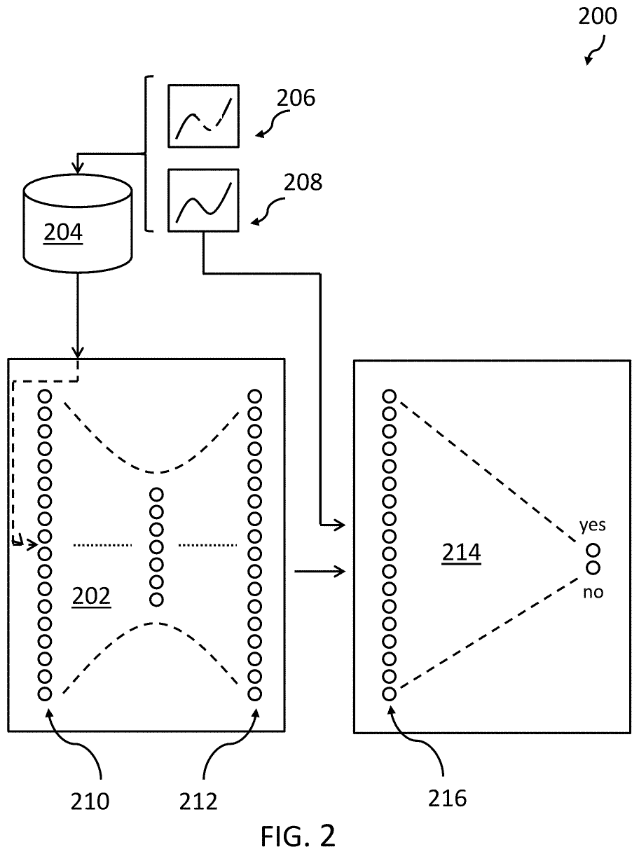

FIG. 2 shows a general setup of the here proposed system used by the proposed method. A generator network 202 with a de-convolutional neural network is trained with training data 204 comprising couples 206, 208 of, e.g., related images. The de-convolutional neural network 202 comprises on the input side 210 (left) and the output side 212 (right) more or less the same number of nodes. The number of nodes in layers between the input layer 210 and the output layer 212 is smaller.

The discriminator 214—e.g., being implemented as a convolutional neural network, comprises, more or less, the same number of input nodes 216 as the generator network 202 has output nodes 212.

Firstly, the two datasets 206, 208 having pairwise related images have to be synthetically generated for training. These datasets comprise the modification of the pattern of interest. Next, the datasets are used to train the GAN model, until it is able to perform the wanted modification. The training continues until the requirements for a loss-based training stop criterion is met. Once the GAN model is ready, the generator 202 is taken apart from the discriminator 214 for a productive use, and new pictures are sent to the generator 202 and modified to the output at the output layer 212.

It may be noted that the discriminator network 214 is shown with two output nodes. It may be used to indicate whether the input data to the discriminator 214 are recognized as artificially generated by the generator 202 or whether the input data to the discriminator 214—which are identical to the output of the generator 202 during training—are original unmodified data from the training dataset. During training, the discriminator 214 is receiving as input output data of the generator 202 as well as original base data samples.

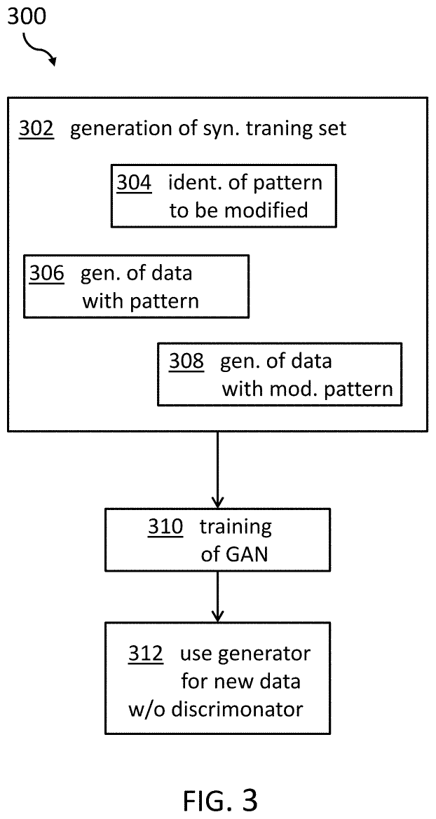

FIG. 3 shows main process steps 300. In the generation 302 of synthetic dataset, the first step is an identification 304 and definition of a pattern that should be modified. This task should be the output of a data sign study on a set of samples that would need to be modified. The study may highlight the most significant pattern in the samples, were the definition of significance can be based on the threshold. This first initialization of the process has to be performed once, at the beginning.

The pattern is then used in order to produce at least two synthetic corresponding datasets. The first synthetic dataset comprises the pattern, and the second dataset comprises the modified pattern. The generation 306 of the synthetic datasets is based on the distinguishing features of the set of initial samples; i.e., through pseudo-random number generators, the features are varied and are added then together to synthesize a temporary set of data, 308. Then, the temporary dataset is deprecated and on one of them, the significant feature is added (or something is taken away), instead of the second one, the addition is the modification of the significant feature.

It is useful in the formation of the datasets that also cases are included that do not have to be modified so that the process learns to cope also with features that do not have to be changed.

The training 310 of the GAN happens as follows: the input of the GAN is the set of images without modifications in the target feature, instead the data that the GAN learns to reproduce is from the set with modified features. It is noteworthy at this step to always coordinate the input data in the data to be reproduced, so that the only feature that changes is the one that should be modified. Hence, the rest of the features have in both, the input data and in the to-be-reproduced version later, the same values for all the other features (controlled by random numbers).

Once the training is completed, the generator part of the GAN is used for a reproduction 312 of new samples with the modifications from an input sample that comprises parts of the features that were abstracted during the separate generation. Thus, the training of the GAN does not require any labeled or annotated data which represents a major relief in manual work load.

Depending on the application of the process, it may also be possible that some of the corrections (i.e., modifications) needed cannot be done in one step, as discussed above. In this case, the process can be serially extended and the modifications can be done one after the other, modifying one pattern at a time. For this, differently trained generators are required.

Before turning to examples of real training and result data, a closer look should be taken at the adaption of the used GAN architecture.

The GAN architecture is created taking inspiration from multiple state-of-the-art architectures such as Pix2Pix, the Super Resolution GAN, while in order to boost the performance, improve the training convergence and decouple the architectures of the generator and discriminator, the Wasserstein loss function is used instead of the adversarial. This novel combination leads to better results compared to any of the components alone on a standard architecture. The following details sketch out technical details of cornerstones of the used GAN network:

The Generator is similar to a U-NET (a special form of a fully convolutional network). This architecture is inspired by the deep convolutional auto-encoders with an extra important benefit; skip connections between corresponding symmetrical convolutional layers in the encoding and decoding part. This way, relevant low level information is passed directly to deeper layers and also training becomes more efficient since skipped layers facilitate gradient backpropagation and gradient vanishing problems can be overcome for deeper networks. Moreover, the absence of dense layers provides the flexibility of testing at different input shapes that the one used for training.

The Discriminator's network is a PatchGAN which is a series of convolutional layers with batch normalization. The difference between this network and a regular discriminator lies in the fact that instead of mapping the input to a single number which corresponds to the probability of the input being real, the input is mapped to an N×N patch instead. Depending on the loss function used, each scalar value of the output patch can either classify if the patch of the input that corresponds to its receptive field is real or not (for adversarial loss) or how real it is (Wasserstein loss). The advancement of this network is first the reduced number of parameters that are needed which result in savings in memory and time, as well as the fact that the architecture can be applied to arbitrary input shapes, which is in the application a needed requirement to enable a generalized and flexible approach.

In the proposed architecture, a weighted combination of different loss functions is applied. First of all, being aware of the fact that pixel-wise MSE (mean square error) and MAE (mean average error) losses tend to produce smoother and blurry results a content loss is used that is based on the feature map of a pre-trained network such as VGG19 (i.e., a CNN trained on more than a million images from the ImageNet database) or ResNet-50 (also a CNN with 50 layers and enabled to classify images into 1000 object categories).

Moreover, instead of using the traditional adversarial loss which is the typical cross entropy for the generator and discriminator, the Wasserstein loss function with gradient penalty is used here, which corresponds to an Earth-Mover distance between the desired data distribution and the generated data distribution. The reason to choose to incorporate this loss function into the here proposed architecture is twofold: first of all, this loss function enhances training stability and achieves quicker convergence without having gradient vanishing problems when critic is trained to optimality. This is an important aspect given the fact that GAN training is fragile and a balanced training between the discriminator and generator is hard to be achieved in general. The second reason lies in the observation that traditional as well as state-of-the-art GAN architectures like Pix2Pix and SRGAN use the adversarial loss and fail to map the loss evolution with the quality of the generated samples. This is not the case in the here proposed implementation; indeed, due to the nature of Wasserstein loss there is a correspondence between the loss and the generator's output quality.

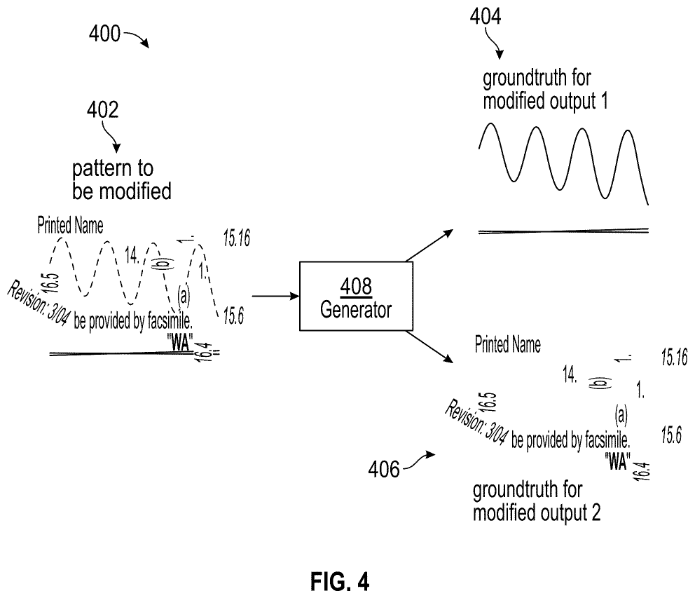

FIG. 4 shows an example 400 of a pattern 402 to be modified and ground truth data for modified output 1 404 and ground truth for modified output 2 406 of the generator 408. The training set is comprised of completely synthetic data that are generated using the principles described above. More precisely, in the shown example of the figure one can see the data pattern that needs to be modified as input to the generator 408, while the desired modified patterns are used as ground truth 404, 406 at the output of the generator. Here, the patterns that are modified for output 1 404 with a single dataset are: (i) dashed lines are transformed into continues once, (ii) randomly missing portions from the lines are filled, (iii) colored image input (not shown) is transformed into a black and white representation, and (iv) text is removed (indirect detection). Output 2 406 comprises all remaining parts of the input without any lines.

The next figures illustrate the achieved performance of the generator in the validation set which is also comprised of images coming from the same synthetic dataset, but which has not been used for training.

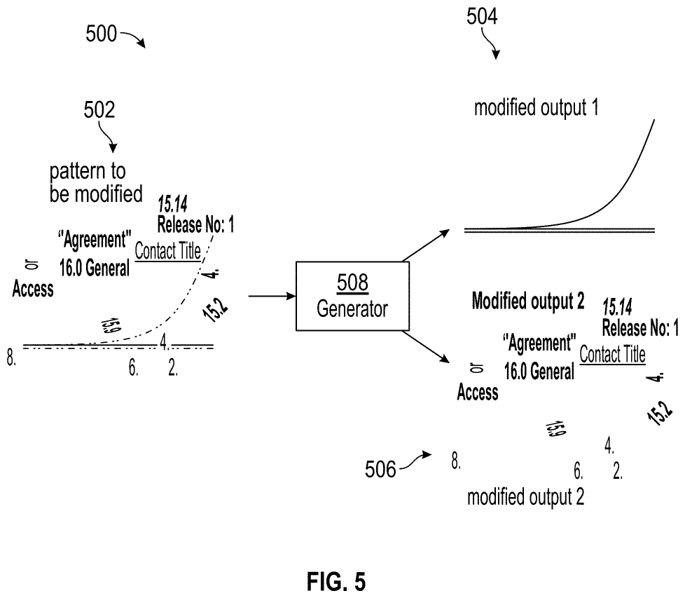

FIG. 5 shows clearly an example 500 transforming a damaged input image 502 to a modified output image 1 504 and modified image output 2 506 by the generator 508.

In order to test the generalization and the scalability of the here proposed approach, the generators extracted after the GAN has completed the training procedure, as described above, and data modification is going to be applied in three different datasets completely area relevant to the training center for synthetic dataset. However, the pattern on the modification was present in the training dataset.

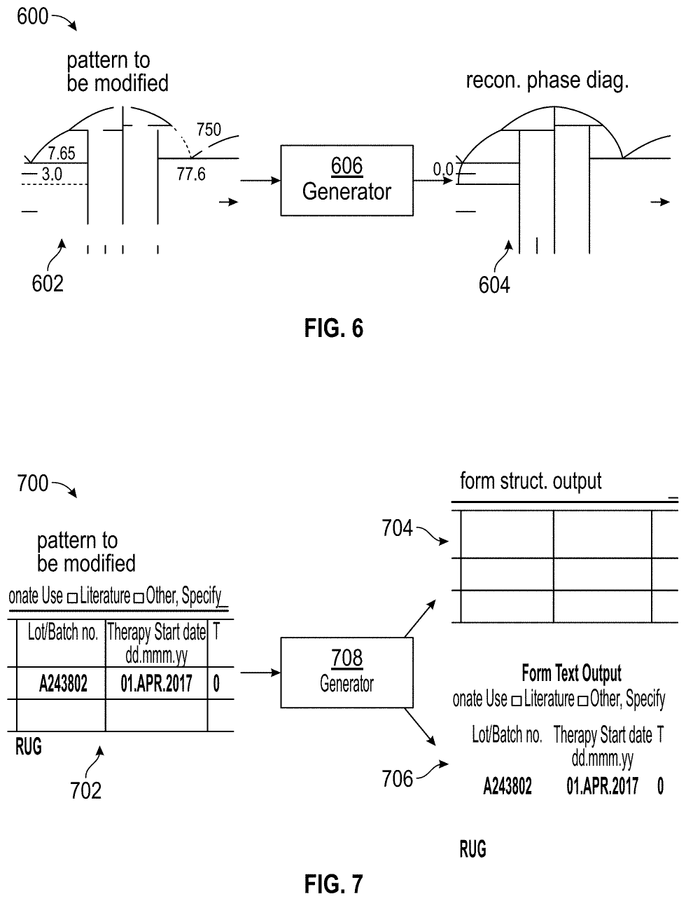

FIG. 6 is an example 600 of a reconstruction of a phase diagram. The reconstruction of the diagram, in this case, can be defined as successful, when the dashed lines of the pattern 602 to be modified are transformed into continues lines and missing parts of the diagram are correctly filled, as shown in the reconstructed phase diagram 604. As can be seen, the generator 606 can perform the task nearly perfectly.

FIG. 7 shows another example 700 involving forms. Here, the task is to modify the form by “decoupling” the lines from the text from the pattern 702 to be modified and vice versa. Consequently, the generator can be “perceived” as form structure extractor (lines only) or text extractor depending on the desired output, as can be seen very good in form of the form structure output 704 and the form text output 706 by the generator 708.

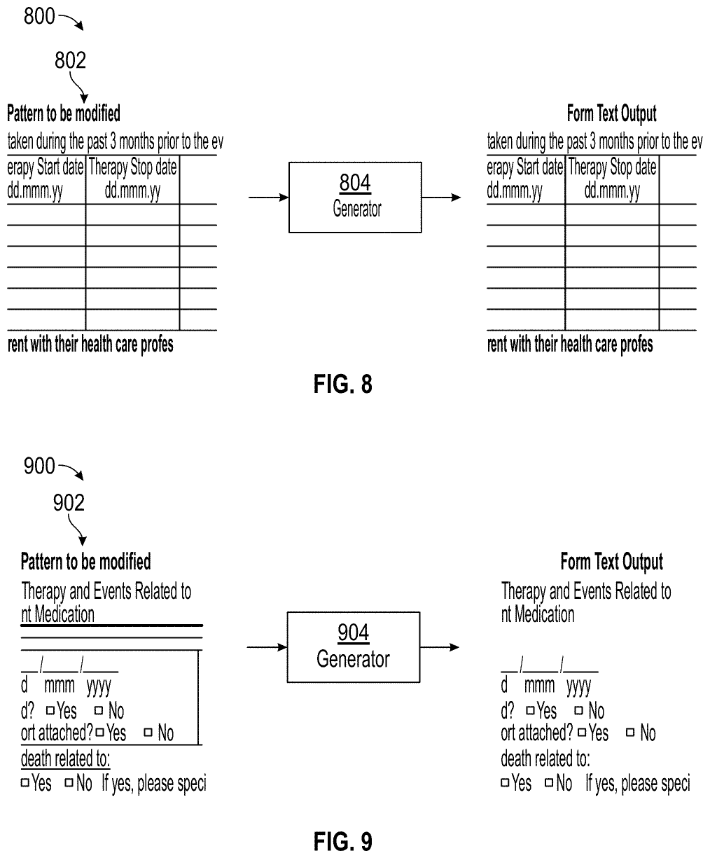

FIGS. 8 and 9 show other examples 800, 900 of a pretty challenging dataset of a very noisy scanned document 802, 902. However, it turns out that the generator 804, 904 fails to perform the task successfully since the input 802, 902 is different from the one of the training dataset you to the presence of high level noise.

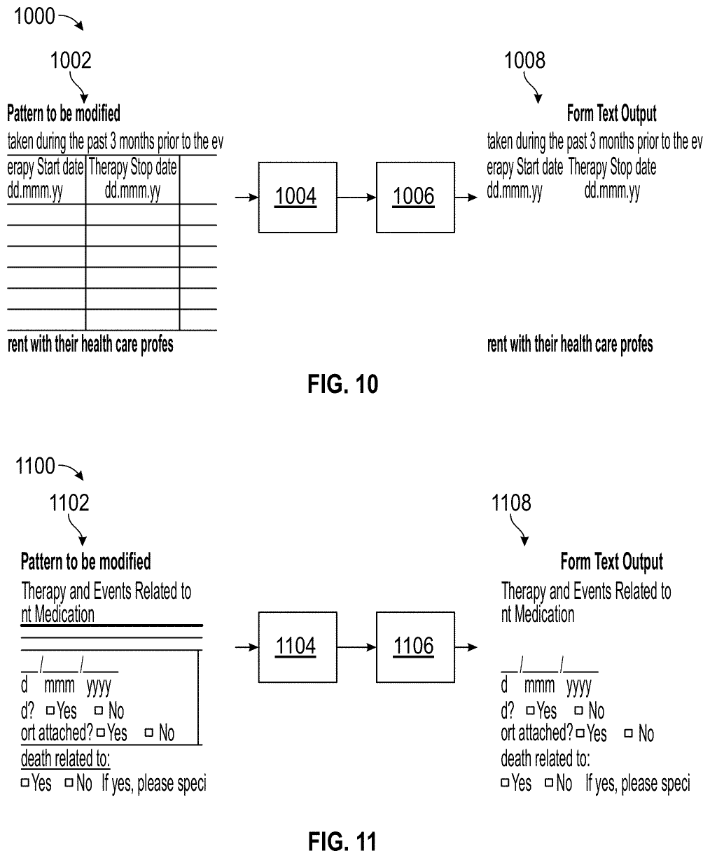

FIGS. 10 and 11 show as examples 1000, 1100 that by putting another generator 1004, 1104 trained to “decoupling” noise from documents in series with the generator 1006, 1106, the text extraction performance is really similar to the one of the examples discussed above. This proves that the efficiency of the proposed method applies also serially to multiple steps with different generators. In FIG. 10, the pattern 1002 to be modified is filtered by a de-noising generator 1004 and a text extraction generator 1006 to generate the form text output 1008.

In FIG. 11, the pattern 1102 to be modified is filtered by a de-noising generator 1104 before the text extraction generator 1106 to generate the form text output 1108.

It may also be noted that everything said related to images is not restricted to images as the examiner depicted above. Indeed, also other use cases can be addressed with the here proposed method, as for example with acoustic data, with text data or other structured data.

With acoustic or sound data, a pattern to the modified could, e.g., be the language accent so that the proposed method can be used to modify the accent in a recording.

With text data, a pattern to be modified could, e.g., be the use of particular expressions and sentences so that the proposed method can change it with other expressions keeping the semantic meaning in the sentence.

With unstructured data, a pattern to be modified could, e.g., be to learn a chronological transformation of financial data of day x versus day x+1. The proposed method can then be applied at the present (x=today) in order to predict tomorrow's trend.

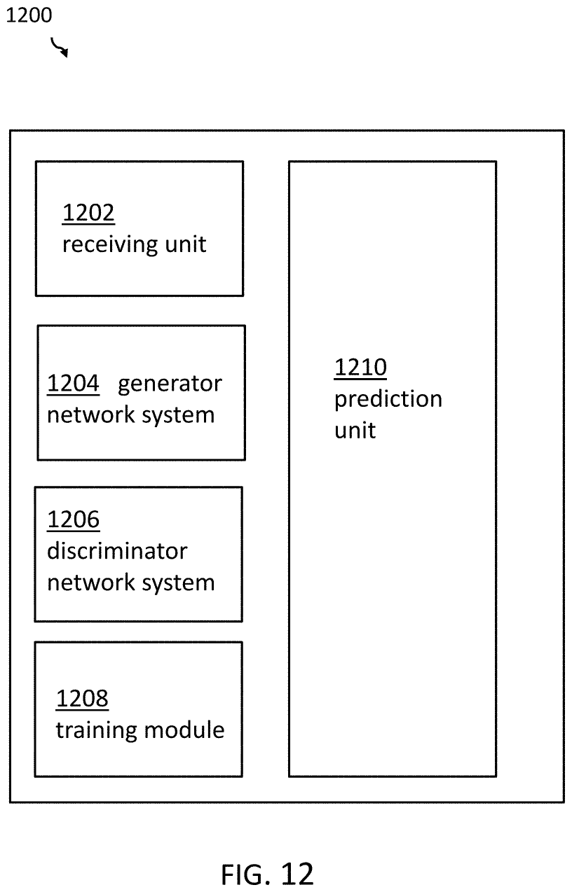

For completeness reasons, FIG. 12 shows an embodiment of the machine-learning system 1200 for modifying patterns in datasets using a generative adversarial network 1202, comprising a generator network system 1204 and a discriminator network system 1206. The machine-learning system 1200 comprises a receiving unit 1202 adapted for providing pairs of data sample. The pairs comprise each a base data sample with a pattern and a modified data sample with a corresponding modified pattern. Thereby, the modified pattern is determined by applying at least one random modification to the base data sample.

The system comprises additionally a training module 1208 adapted for controlling a training of the generator network system for building a model of the generator network system using an adversarial training method and using the pairs of data samples as input. The discriminator network system 1206 receives as input dataset pairs of datasets. The dataset pairs comprise each a prediction output of the generator network system 1202 based on a base data sample and the corresponding modified data sample; thereby, a joint loss function for the generator and the discriminator may be optimized.

Last but not least, the system 1200 comprises a prediction unit 1210 adapted for predicting an output dataset for unknown data samples as input for the generator without the discriminator.

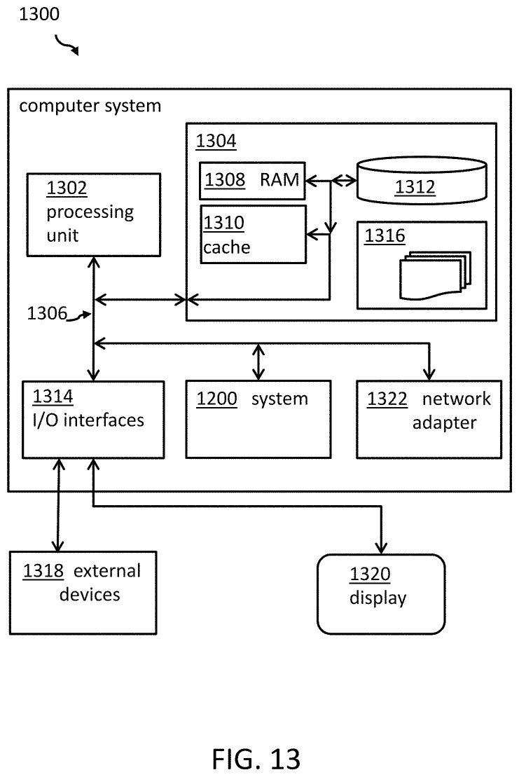

Embodiments of the invention may be implemented together with virtually any type of computer, regardless of the platform being suitable for storing and/or executing program code. FIG. 13 shows, as an example, a computing system 1300 suitable for executing program code related to the proposed method.

The computing system 1300 is only one example of a suitable computer system, and is not intended to suggest any limitation as to the scope of use or functionality of embodiments of the invention described herein, regardless, whether the computer system 1300 is capable of being implemented and/or performing any of the functionality set forth hereinabove. In the computer system 1300, there are components, which are operational with numerous other general purpose or special purpose computing system environments or configurations. Examples of well-known computing systems, environments, and/or configurations that may be suitable for use with computer system/server 1300 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 1300 may be described in the general context of computer system-executable instructions, such as program modules, being executed by a computer system 1300. Generally, program modules may include routines, programs, objects, components, logic, data structures, and so on that perform particular tasks or implement particular abstract data types. Computer system/server 1300 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 1300 is shown in the form of a general-purpose computing device. The components of computer system/server 1300 may include, but are not limited to, one or more processors or processing units 1302, a system memory 1304, and a bus 1306 that couple various system components including system memory 1304 to the processor 1302. Bus 1306 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 1300 typically includes a variety of computer system readable media. Such media may be any available media that is accessible by computer system/server 1300, and it includes both, volatile and non-volatile media, removable and non-removable media.

The system memory 1304 may include computer system readable media in the form of volatile memory, such as random access memory (RAM) 1308 and/or cache memory 1310. Computer system/server 1300 may further include other removable/non-removable, volatile/non-volatile computer system storage media. By way of example only, a storage system 1312 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 1306 by one or more data media interfaces. As will be further depicted and described below, memory 1304 may include at least one program product having a set (e.g., at least one) of program modules that are configured to carry out the functions of embodiments of the invention.

The program/utility, having a set (at least one) of program modules 1316, may be stored in memory 1304 by way of example, and not limiting, as well as an operating system, one or more application programs, other program modules, and program data. Each of the operating systems, one or more application programs, other program modules, and program data or some combination thereof, may include an implementation of a networking environment. Program modules 1316 generally carry out the functions and/or methodologies of embodiments of the invention, as described herein.

The computer system/server 1300 may also communicate with one or more external devices 1318 such as a keyboard, a pointing device, a display 1320, etc.; one or more devices that enable a user to interact with computer system/server 1300; and/or any devices (e.g., network card, modem, etc.) that enable computer system/server 1300 to communicate with one or more other computing devices. Such communication can occur via Input/Output (I/O) interfaces 1314. Still yet, computer system/server 1300 may communicate with one or more networks such as a local area network (LAN), a general wide area network (WAN), and/or a public network (e.g., the Internet) via network adapter 1322. As depicted, network adapter 1322 may communicate with the other components of the computer system/server 1300 via bus 1306. It should be understood that, although not shown, other hardware and/or software components could be used in conjunction with computer system/server 1300. Examples, include, but are not limited to: microcode, device drivers, redundant processing units, external disk drive arrays, RAID systems, tape drives, and data archival storage systems, etc.

Additionally, the machine-learning system 1200 for modifying patterns in datasets using a generative adversarial network may be attached to the bus system 1306.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for modifying patterns in datasets, the method using a generative adversarial network comprising a generator and a discriminator, the method comprising:
providing pairs of data samples, the pairs comprising each a base data sample with a pattern and a modified data sample with a corresponding modified pattern, wherein the modified pattern is determined by applying at least one random modification to the base data sample,
training of the generator for building a model of the generator using an adversarial training method and using the pairs of data samples as input, wherein the discriminator receives as input dataset pairs of datasets, the dataset pairs comprising each a prediction output of the generator based on a base data sample and the corresponding modified data sample, thereby optimizing a joint loss function for the generator and the discriminator, and
predicting an output dataset for unknown data samples as input for the generator without the discriminator.

2. The method according to claim 1, wherein the joint loss function is a Wasserstein loss function.

3. The method according to claim 1, further comprising training of different models for the generator network using the adversarial training method and using the pairs of data samples as input, wherein the modified data sample are modified according to a different aspect.

4. The method according to claim 1, wherein the generator is a neural network having as many output nodes as input nodes, and having less hidden layer nodes than the number of input nodes.

5. The method according to claim 1, wherein the discriminator is a neural network having as many input nodes as the generator has output nodes and having two output nodes.

6. The method according to claim 1, wherein the discriminator is a PatchGAN.

7. The method according to claim 1, wherein the joint loss function is a weighted combination of loss functions.

8. The method according to claim 1, wherein the loss function is related to content loss of the base data sample and wherein the content loss is determined using a feature map of a pre-trained neural network.

9. The method according to claim 1, wherein the modified data sample comprises, in contrast to the relating data samples, continuous lines instead of dashed lines, black-and-white instead of equivalent colored pattern, text-less pattern instead of pattern with text, and line-free image instead of mixed line/text image.

10. The method according to claim 1, wherein the providing pairs of data samples comprises:
providing a set of images with patterns,
determining at least one pattern to be modified,
randomly modifying the at least one pattern of the images using a random number generator, and
relating one out of the set of images and a related image with the at least one pattern defining one of the pairs comprising the base data sample and the modified data sample.

11. The method according to claim 1, wherein the training of the generative adversarial network is terminated if a result of the joint loss function is smaller than a relative threshold value when comparing the result of the current iteration with a previous iteration.

12. The method according to claim 1, wherein the base data sample and a modified data sample are images.

13. A machine-learning system for modifying patterns in datasets using a generative adversarial network, comprising a generator network system and a discriminator network system, the machine-learning system comprising
a receiving unit adapted for providing pairs of data samples, the pairs comprising each a base data sample with a pattern and a modified data sample with a corresponding modified pattern, wherein the modified pattern is determined by applying at least one random modification to the base data sample,
a training module adapted for controlling a training of the generator network system for building a model of the generator network system using an adversarial training method and using the pairs of data samples as input, wherein the discriminator network system receives as input dataset pairs of datasets, the dataset pairs comprising each a prediction output of the generator based on a base data sample and the corresponding modified data sample, thereby optimizing a joint loss function for the generator and the discriminator, and
a prediction unit adapted for predicting an output dataset for unknown data samples as input for the generator without the discriminator.

14. The system according to claim 13, wherein the joint loss function is a Wasserstein loss function, and/or
wherein the system trains different models for the generator network using the adversarial training method and using the pairs of data samples as input, wherein the modified data sample are modified according to a different aspect.

15. The system according to claim 13, wherein the generator network system is a neural network having as many output nodes as input nodes, and having less hidden layer nodes than the number of input nodes, or
wherein the discriminator network system is a neural network having as many input nodes as the generator has output nodes and having two output nodes.

16. The system according to claim 13, wherein the discriminator is a PatchGAN system.

17. The system according to claim 13, wherein the loss function is related to content loss of the base data sample and wherein the content loss is determined using a feature map of pre-trained neural network.

18. The system according to claim 13, wherein the providing pairs of data samples comprises
providing a set of images with patterns,
determining at least one pattern to be modified,
randomly modifying the at least one pattern of the images using a random number generator, and
relating one out of the set of images and a related image with the at least one pattern defining one of the pairs comprising the base data sample and the modified data sample.

19. The method according to claim 13, wherein the base data sample and a modified data sample are images.

20. A computer program product for modifying patterns in datasets using a generative adversarial network comprising a generator network system and a discriminator network system, the computer program product comprising a computer readable storage medium having program instructions embodied therewith, said program instructions being executable by one or more computing systems or controllers to cause said one or more computing systems to:
provide pairs of data samples, the pairs comprising each a base data sample with a pattern and a modified data sample with a corresponding modified pattern, wherein the modified pattern is determined by applying at least one random modification to the base data sample,
train the generator for building a model of the generator using an adversarial training method and using the pairs of data samples as input, wherein the discriminator receives as input dataset pairs of datasets, the dataset pairs comprising each a prediction output of the generator based on a base data sample and the corresponding modified data sample, thereby optimizing a joint loss function for the generator and the discriminator, and
predict an output dataset for unknown data samples as input for the generator without the discriminator.
